(19) United States
(12) Patent Application Publication
(10) Pub. No.: US 2005/0125534 A1
(43) Pub. Date: Jun. 9, 2005

(54) Group management system and method

(76) Inventor: Jeffrey D. Gatt, Plymouth, MI (US)

Correspondence Address: SIMON, GALASSO & FRANTZ PLC., P.O. Box 26503, Austin, TX, 78755-0503, US

(21) Appl. No.: 10/729,075

(22) Filed: Dec. 5, 2003

(51) Int. Cl. G06F 15/173

(52) U.S. Cl. 709/225

(57) ABSTRACT

A group management system comprises a plurality of functionally modules. An information management module is configured for managing information (i.e., group information) associated with a group of members and a group activity participated in by the members. A group activity publishing module is configured for facilitating creation of a group activity publication layout. A communication module is configured for automatically creating and for dynamically maintaining a website structure instantiation. Facilitating creation of the group activity publication layout is performed dependent upon accessing at least a portion of the group information maintained by the information management module. Creating and maintaining the website structure instantiation are each performed dependent upon accessing at least a portion of the group information.

### FIELD OF THE DISCLOSURE

The disclosures made herein relate generally to computer-implemented methodologies and systems and, more particularly, to group management systems and methods.

### BACKGROUND

There are a number of providers of on-line team websites and team management, which are accessible over the Internet. These types of team organization and team management providers offer free and for-fee website and team management packages. Their services range from very basic website informational functionality to full suites of team management tools. None of these systems offer integrated publication functionality, such as that for creating an end-of-season momento book.

There are currently many off-the-shelf desktop publishing applications that enable the creation of a personalized memory book, and a multitude of “scrap booking” applications. There are also many on-line scrapbook providers that allow the end user to assemble photos into a scrapbook and add some level of written content (e.g., photo captions and some free flowing commentary). On-line yearbook creation and publication providers geared specifically to the traditional high school yearbook are also known. These on-line yearbook creation and publication providers are specifically targeting the traditional school yearbook service and yearbooks for home-schooled children.

However, none of these known conventional offerings has integrated information management, group communication and group publication functionalities into a single on-line or standalone application. For example, none of these offering allows for simple, yet detailed, sets of information to be entered into a single computer-implemented system (e.g., by multiple group members) and for the computer implemented system to facilitate automated manipulation of such entered information for providing integrated information management, group communications, and group publication functionalities.

Furthermore, these known solutions are generally very cumbersome to use and require a steep learning curve to understand how the software application or website works. In addition, due to the fact that many of these known software applications are limited to use on only one PC, the information management and document creation functionality becomes a one-person job. Also, the files required for creating a image-rich memory book are usually very large and therefore are not easily shared via email between members of the group and the person managing the information. Finally, the manner in which these know solutions allow gathered information to be printed and bound often results in relatively a low quality product from a graphic layout and printed publication standpoint.

Therefore, methods and systems configured for facilitating information management, group communication and group activity publication functionalities in a manner that overcomes the limitations and drawbacks associated with conventional solutions for providing such functionalities would be useful and advantageous.

### SUMMARY OF THE INVENTION

In accordance with one embodiment of the disclosures made herein, a computer-implemented method for facilitating group management functionality comprises maintaining a group instantiation including information (i.e., group information) representing a group of members and a group activity participated in by the members, creating a website structure instantiation including content fields corresponding to at least a portion of the group information, and creating a group activity publication layout including content fields corresponding to at least a portion of the group information. Maintaining the information instantiation is performed by an information management module of a group management system, creating the website structure instantiation is performed by a group communication module of the group management system, and creating the group activity publication layout is performed by a group activity publication module of the group management system.

In accordance with another embodiment of the disclosures made herein, a group management system comprises a plurality of functionally modules. An information management module is configured for managing information (i.e., group information) associated with a group of members and a group activity participated in by the members. A group activity publishing module is configured for facilitating creation of a group activity publication layout. A communication module is configured for automatically creating and for dynamically maintaining a website structure instantiation. Facilitating creation of the group activity publication layout is performed dependent upon accessing at least a portion of the group information maintained by the information management module. Creating and maintaining the website structure instantiation are each performed dependent upon accessing at least a portion of the group information.

### BRIEF DESCRIPTION OF THE DRAWING FIGURES

FIG. 1 depicts an embodiment of a group management system in accordance with an embodiment of the disclosures made herein.

FIG. 2 depicts a method for manipulating information compiled by members of a group in accordance with an embodiment of the disclosures made herein.

FIG. 3 depicts a website structure in accordance with an embodiment of the disclosures made herein.

FIG. 4 depicts an embodiment of an administrator home page corresponding to the group administrator access level of the website structure depicted in FIG. 3.

FIG. 5 depicts an embodiment of an activity participant home page corresponding to the group member access level of the website structure depicted in FIG. 3.

FIG. 6 depicts a method of facilitating creation of a group activity publication by a group administrator in accordance with an embodiment of the disclosures made herein.

FIG. 7A depicts a webpage that is configured for enabling selection of optional content sections for a group activity publication template.

FIG. 7B depicts a webpage that is configured for enabling designation of a profile layout type and a plurality of participant profile content selections.

FIG. 7C depicts a webpage that is configured for enabling specification of a plurality of questions upon which at least a portion of profile content for a group activity publication template is determined.

FIG. 8 depicts a webpage that is configured for enabling various editing and approval functionality (i.e., formatting functionality) to be facilitated for a group activity publication layout.

FIG. 9A depicts a webpage that is configured for managing uploaded images.

FIG. 9B depicts a webpage that is configured for uploading images.

### DETAILED DESCRIPTION OF THE DRAWING FIGURES

The disclosures made herein relate to methods and systems configured for manipulating information compiled by members of a group. Examples of functionality associated with such manipulation includes managing members of a group, processing information compiled by the group, facilitating communication between all or a portion of a group, and creating a group publication such as an end-of season teambook. Such functionality is at least partially enabled as a result of corresponding methods and systems being configured for providing information management, group communication and group activity publication functionalities in an integrated manner. Through such integration of functionalities, manipulation of such information is accomplished more simply and effectively than with related conventional systems and methods.

More specifically, methods in accordance with embodiments of the disclosures made herein and systems configured for carrying out such methods provide means for simplifying and enhancing a group's participation in a group activity. Such methods and systems advantageously integrate information management, group communication and group publication functionalities into a network-based solution. In accordance with such embodiments, simple sets of information (e.g., readily available and known) are inputted into a single computer-implemented system, which facilitates various novel methodologies for providing such integrated information management, group communications, and group publication functionalities.

Facilitating compilation of required information and associated manipulation of such information in accordance with the disclosures made herein is relatively simple in that implementation of embodiments of the methodologies disclosed herein does not require a steep learning curve by group members. Due at least partially to such simplicity, multiple members of a group (e.g., the entire group) contribute to compiling information of the group and facilitating manipulation of such information. In doing so, the burden of such information entry and facilitating manipulation is advantageously shared among multiple persons rather than a simple person.

Utility and implementation of methods and systems in accordance with embodiments of the disclosures made herein are advantageously applicable to groups of many types. While a baseball team is presented herein as the exemplary type of group, it will be apparent (e.g., to one of ordinary skill in the related arts) that the core aspects of such methods and system may be applied to other types of groups. Accordingly, it is contemplated herein that embodiments of the methods and systems disclosed herein are fully adaptable to accommodate the various content and context of information associated with such various groups. As such, embodiments of the methods and systems disclosed herein are not limited to any particular type of group or information associated with any particular type of group.

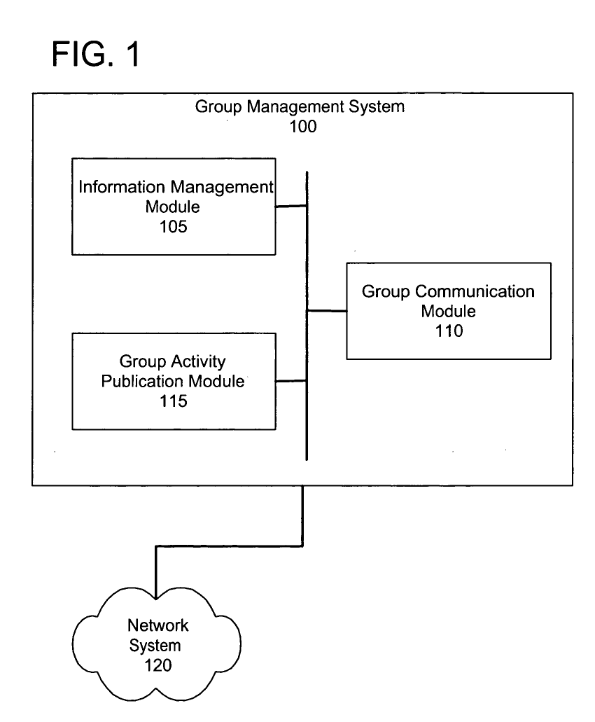

Referring now to specific figures, FIG. 1 depicts an embodiment of a group management system 100 in accordance with an embodiment of the disclosures made herein. The group management system 100 includes an information management module 105, a group communication module 110 and a group activity publication module 115. The group management system 100 is connected to a network system 120 (e.g., through a network interface device of the group management system 100, which is not shown) for enabling input, access and sharing of information via public and/or private computer networks (e.g., via the Internet). Each module may comprise data processor instructions (e.g., in the form of software), hardware or a combination thereof. Furthermore, such modules may share all or a portion of such data processing instructions and hardware.

Through its various modules, the group management system 100 provides distinct, yet highly integrated functionalities for manipulating information compiled by members of a group. Specifically, the modules of the group management system 100 are configured for facilitating information management, group communication and group activity publication functionalities. Information management functionality, which is facilitated via the information management module 105, simplifies the administrative burden associated with coordinating operations of a group and its members (e.g., amateur sports teams, extra-curricular groups and their associated group activities). Examples of information management functionality include enabling entry and maintenance of group member profile information, sponsor information, group activity results and the like. Group communication functionality, which is facilitated via the group communication module 110, enables complete on-line communication between the various members of a group as well as their family and fans through access to a collection of private and public website. Examples of group communication functionality include automated website structure creation and maintenance, automated and administrator-implemented group e-mail messages, system-generated e-mail messages and website postings and the like. Group activity publication functionality, which is facilitated via the group activity publication module 115, enables information compiled by the members of the group to be used for dynamically creating a content-rich, full-color, professionally-bound, and personalized group activity publication. Examples of such a group activity publication include a season-end team book for a sports team, a yearbook for a scholastic extra-curricular activity group and the like.

The information management module 105 enables group and activity related information to be entered, maintained and manipulated in a simple and effective manner. For example, group members and a group administrator may enter and maintain respective portions of group information in a consistent, organized and secure manner. The group members entering and maintaining their personal information and the group administrator entering and maintaining group and activity related information. This information dynamically updates the information utilized by the group communication module 110 and the group activity publication module 115 for enabling their respective functionalities to be performed. Through use of such information by multiple modules, repeated entry of the same information at different applications or functional modules is precluded.

The information management module 105 provides a user interface for allowing a group administrator (e.g., a coach) to input all the information necessary to build a framework for their group's on-line presence (i.e., in one embodiment, a system-generated website structure) and group information that may be dynamically integrated into a group activity publication. Using this user interface, the group administrator inputs and assigns group staff roles and responsibilities, inputs a group member listing (e.g., a team roster), inputs a schedule of activity events (e.g., all of a team's games, practices, other group events), inputs sponsor information, and uploads team documents (e.g., medical forms, waivers, releases, rules, etc). As the administrator inputs information, the information management module 105 dynamically creates rosters, schedules, and other documents, and provides print-ready versions of such documents so that hard copies may be printed as desired.

The group communication module 110 utilizes network-based communication technologies for enabling messages to be sent automatically and manually to recipients such as an entire group community or predefined subsets of such a community. A team community that includes coaches, players, parents, and other “opt-in” family and fans is an example of a group community. The group communication module employs such network-based communication technologies for communicating important news, announcements and updates to all or a portion of members of a group (e.g., subscribed members, family and fans). Examples of content communicated via the communication module include information relating to weather, updates/changes to group activity schedules, group activity results and statistics, group organization news and announcements, group news and announcements, group and group activity photos and other information of interest/necessity. E-mail, instant messaging, Windows brand messaging, group messaging, system-generated website postings and the like are examples of such network-based communication technologies.

Additionally, the group communication module 110 dynamically creates a website structure for providing the group with an on-line presence through which information can be shared. Content of the website comprises system-defined portion of information managed by the information management module 105 as well as user-defined information. The system-defined portion of information is integrated into the website in an automated manner and is dynamically maintained in response to such information being altered (i.e., dynamically-maintained information). In this manner, system defined content of the website remains up to date with respect to information managed by the information management module 105. As discussed below in greater detail, system-generated and administrator-generated announcements can be posted via the website structure for private and/or public viewing. Accordingly, the group communication module 110 allows for authorized administrators and/or group members to disseminate information by posting announcements to the group's website structure and/or sending e-mails to desired portions of the group's community.

The group activity publication module 115 facilitates information inputted by multiple group members to be dynamically integrated into layouts corresponding to one or more system-offered group activity publications (i.e., group activity publication layouts). Content of such group activity publication layouts comprise system-defined portions of information managed by the information management module 105. Such information is integrated into group activity publication layouts in an automated manner. Because such content is dynamically associated with information managed by the information management module 105, content of such group activity publication layouts remains up to date with respect to information managed by the information management module 105.

To accommodate groups that do not have a “season”, per se, or the need for results (scores, highlights, etc.), a group management systems in accordance with at least one embodiment of the disclosures made herein allows for various functionalities and content fields to be user-selectable. Furthermore, certain features specifically intended to accommodate the extra-curricular type groups rather than team type groups are user-selectable. With this degree of flexibility and adaptability, a group management system in accordance with an embodiment of the disclosures made herein has applicability to a broad array of markets and groups.

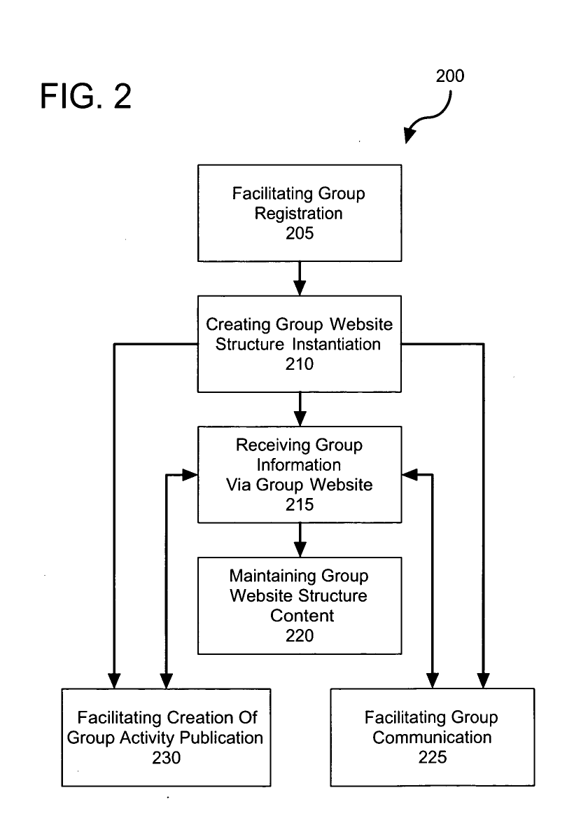

FIG. 2 depicts a method 200 for manipulating information compiled by members of a group in accordance with an embodiment of the disclosures made herein. Such manipulation includes utilizing such information for facilitating information management, group communication and group activity publication functionalities as disclosed herein. The method 200 is capable of being carried out by a group management system in accordance with embodiments of the disclosures made herein.

The method 200 includes an operation 205 configured for facilitating group registration. Facilitating group registration includes receiving group registration information and, in response to required information being provided, issuing a username and password for at least a portion of the group members. For example, in response to a registrant for a group (e.g., a team's coach) providing required group registration information, a user identifier and passcode are assigned to the registrant. When required information (e.g., name and e-mail address) for other group members (e.g., team players) is provided during the registration process, a user identifier and passcode are assigned to each one of such other group members.

One embodiment of facilitating group registration includes displaying system-defined group registration information entry fields via a website, receiving information inputted into such fields and capturing such information in respective fields of an information management module of a group management system (e.g., the information management system 105 of the group management system 100). Examples of information of which the group registration information is comprised includes group name, organization name for the group activity in which the group participates, type of activity, period over which the activity is conducted and group contact information and registration payment information.

After facilitating group registration (i.e., once the group is registered), an operation 210 is performed for creating a website structure instantiation for the group. The website structure instantiation is displayable (e.g., via a web browser) as the group website. The website structure instantiation is created in an automated manner dependent upon the group registration information.

Creating the website structure instantiation includes populating content fields of a website template instantiation with system-defined portions of the group registration information, thereby creating the website structure instantiation with populated and unpopulated content fields. In at least one embodiment, the website template structure is an informational template that defines relational information structures such as display parameters for content and associations between group information (e.g., maintained via an information module of a group management system) and website content fields. Prescribed portions of group registration information and yet to be received group information comprise the content of the website structure instantiation. In one embodiment, the website structure instantiation is configured for enabling content selection functionality and activity publication creation functionality; includes a plurality of system defined content fields and a plurality of user-specified content fields, and is configured for allowing controlled-access to each of a plurality of website structure access levels.

After creating the website structure instantiation, an operation 215 is performed for receiving group information via the group website. One embodiment of receiving group information via the website includes displaying system-defined group information entry fields, receiving information inputted into such fields and capturing such information in respective fields of an information management structure. Examples of group information include graphical and textual group indicia, group member profile information (e.g., participants, staff, etc), group activity results and statistics, group activity scheduling information, sponsorship information, group name, organization name for the group activity and free-form narrative comments.

Group information is received from a plurality of group members, and comprises system-required information as well as narrative (e.g., non-system required) information. The system-required information represents that information required by the system for enabling various system functionalities to be carried out. At least a portion of the information provided by each group becomes content of the group website. Primary information contributors include a group administrator (e.g., a coach) and group activity participants (e.g. players in a sporting activity).

A group instantiation is defined herein to comprise at least a portion of group registration information and group information. The group instantiation is a representation of the group, which may be in the form of a database structure, an object environment or other know types of information management structures. An example of information of which the group instantiation is comprised includes group indicia, group member information and group activity information.

In one embodiment, the group information includes an administrator dataset and a plurality of participant datasets. The administrator dataset includes administrator content for at least one of a group activity publication and a website structure instantiation, and includes content parameters for at least one of the group activity publication and the website structure instantiation. Each one of the participant datasets includes participant content for at least one of the group activity publication and the website structure instantiation In response to receiving group information, an operation 220 is performed for maintaining content fields of the website structure instantiation, as appropriate. For example, when a group administrator enters results for an activity, the appropriate content field or fields of the website structure instantiation is populated or updated such that those results are accessible (i.e., displayable) via the group website. In this manner, content fields of the website structure instantiation are dynamically maintained in response to receiving respective portions of group information. Maintaining a content field may include updating information in a content field that has been previously populated or populating an empty content field.

After creating the group website structure instantiation and enabling access to the corresponding group website, an operation 225 for facilitating group communication is enabled and an operation 230 for facilitating creation of a group activity publication is enabled. The condition exists where the operation 225 for facilitating group communication and the operation 230 for facilitating creation of the group activity publication each required additional group information to be received (i.e., group information that has not already been received). Accordingly, the operation 215 for receiving group information via the group website is at least sometimes performed in conjunction with the operation 225 for facilitating group communication and the operation 230 for facilitating creation of the group activity publication. In such instances, requests for information are made (e.g., prompting a website user for information) and the requested information is inputted by the user via the group website.

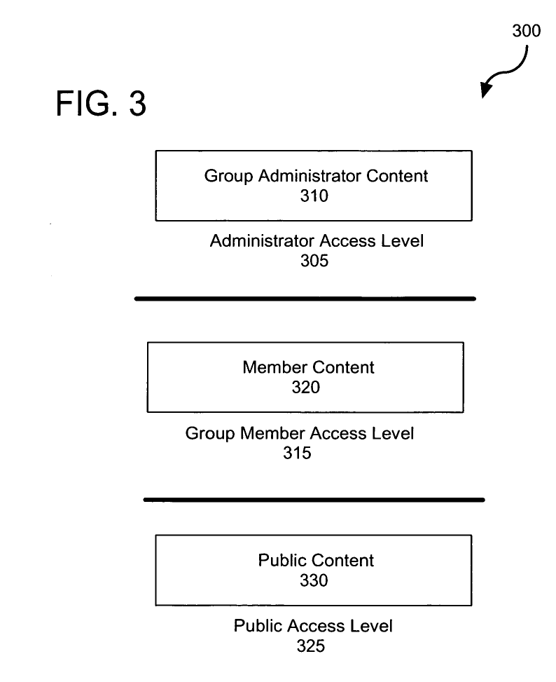

FIG. 3 depicts a website structure 300 in accordance with an embodiment of the disclosures made herein. The website structure 300 is an embodiment of a website structure created at the operation 210 in FIG. 2. The website structure 300 includes a plurality of access levels, each having corresponding content components. A group administrator access level 305 (i.e., a first level of access) provides access to corresponding administrator content 310. A group member access level 315 (i.e., a second level of access) provides access to corresponding group member content 320. A public access level 325 (i.e., a third level of access) provides access to corresponding public content 330. The public content 330 accessible at the public access level 325 is limited to being displayable (e.g., not editable) and is a subset of the content entered, edited and or displayed via the group administrator access level 305 and/or the group member access level 315.

Content selection functionality for other access levels and activity publication creation functionality are exclusively accessible through the group administrator access level. The second access level includes a plurality of respective content fields. A first portion of the content fields of the second access level is system-defined and a second portion of the content fields of the second access level is specified through the first access level (i.e., by the group administrator). The third access level includes publicly accessible content inputted exclusively though at least one of the first access level and the second access level. In one embodiment, the first access level consists of access limited by a group administrator passcode, the second access level consists of access limited by group member passcodes, and the third access level consists of unrestricted access.

Input of information associated with content selection of at least one of a website structure instantiation and a group activity publication layout is facilitated through the first level of access. Input of results associated with a group activity is facilitated through at least one of the first level of access and the second level of access.

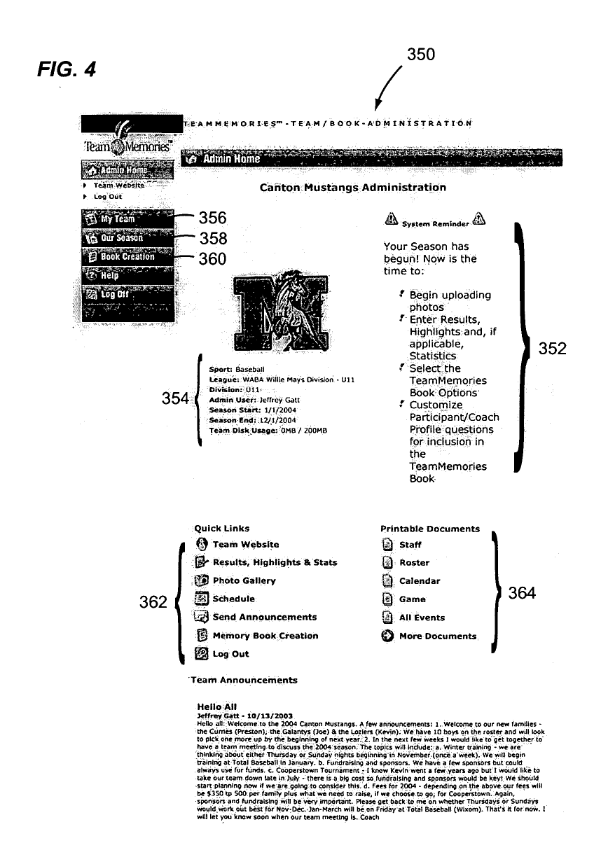

FIG. 4 depicts an embodiment of an administrator home page 350 corresponding to the group administrator access level 305 of the website structure 300 depicted in FIG. 3. Specifically, the administrator home page 350 is a home page for the administrator of a youth baseball team. The administrator home page 350 provides a group administrator with access to a number of content fields, which are accessible exclusively through the administrator home page 350. System-generated messages for prompting the administrator of various tasks and functions are posted at a system message field 352. Administrator-exclusive summary information, which is system defined, is posted at a summary field 354.

Information associated with the team community, team participant roster, team staff roster, team activity schedule, team forms, team sponsors, website links, game results, game statistics, game highlights, e-mail lists and announcement lists is entered and/or edited through access via a “Team Management” webpage, which is accessible by selection of a “Team Management” tab 356 (i.e., a first webpage of the administrator home page 350). Functionalities associated with managing and uploading team images (e.g., photos) are access via a “Photo Management” webpage by selection of a “Photo Management” tab 358 (i.e., a second webpage of the administrator home page 350). Functionality associated with publishing a team momento book (i.e., group publication functionality) is accessible via a “Book Creation” webpage by selection of a “Book Creation” tab 360 (i.e., a third webpage of the administrator home page 350). A plurality of “Quick Links” selections 362 provides access to corresponding information. A plurality of “Printable Documents” selections 364 provides access to corresponding group documents (e.g., forms).

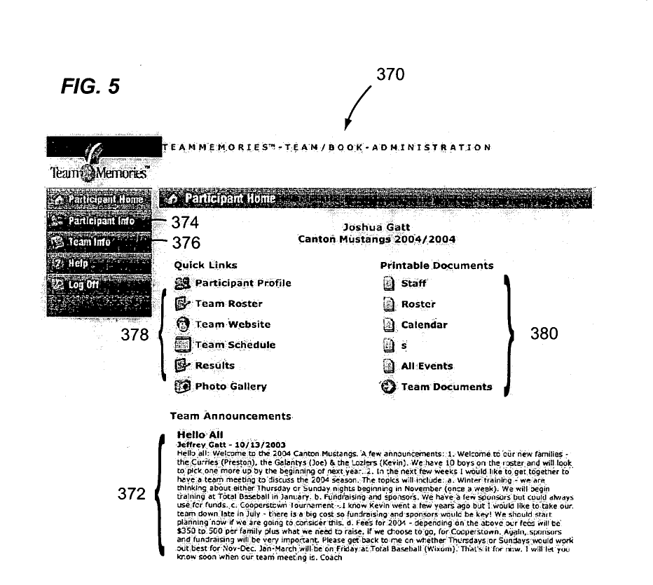

FIG. 5 depicts an embodiment of an activity participant home page 370 (i.e., a group member home page) corresponding to the group member access level 315 of the website structure 300 depicted in FIG. 3. Specifically, the activity participant home page 370 is a home page for a player (i.e., the activity participant) of a youth baseball team. The activity participant home page 370 provides the activity participant with access to a number of content fields, which are exclusively accessible via the activity participant home page. An administrator-generated message (i.e., created through access to the administrator home page) is presented at a team announcement field 372.

Information associated with the participant's profile and comments by the participant's immediate community (e.g., family members) is entered and/or edited through access via a “Participant Information” webpage by selection of a “Participant Information” tab 374 (i.e., a first webpage of the activity participant home page 370). A team participant roster, team staff roster and team documents are viewable and/or printable through access via the “Participant Information” webpage. Public access level website content, game statistics, game highlights and team photos viewable through access via a “Team Information” webpage by selection of a “Team Information” tab 376 (i.e., a second webpage of the activity participant home page 370). A plurality of “Quick Links” selections 378 provides access to (e.g., to enter, edit, view and/or print) corresponding information. A plurality of “Printable Documents” selections 380 provides access to (e.g., to view and/or print) corresponding group documents (e.g., forms).Turning now to a detailed discussion on an embodiment of group activity publication functionality in accordance with the group management system 100, the advantages and benefits of group activity publication functionality (i.e., provided via the group activity publication module 115) stem from its integration within the group management system 100. Content of a group activity publication created via the group activity publication module 115 is largely comprised of group information maintained by the information management module 105. In this manner, a majority (e.g., up to about 75%-80%) of the content of the group activity publication is automatically accessed (e.g., including being extracted) from the information management module 105.

Through the administrator access level of the group website, the group administrator simply designates group indicia such as team colors, designates which ones of a plurality of system-offered publication sections are to be included in the group activity publication and designates files for photos required for the designated publication sections. Advantageously, information maintained by the information management module 105 dynamically populates the various content fields of the publication sections. As the group members add or edit information, corresponding changes to the content of the group activity publication are automatically made. Furthermore, because the group activity publication functionality is integral within the group management system 100, the administrator is not required do any programming, use any dedicated publication software or re-enter any information. When prompted, functionality facilitated by the group activity publication module 115 performs the required operations for creating and outputting a print-ready group activity publication layout.

Accordingly, such group activity publication functionality is novel and advantageous in that it is fully integrated within the group management system and dynamically populates the various content fields of publication sections. While the resulting group activity publication layout is extremely detailed and professional, the group activity publication functionality makes its creation simple and saves time. The group activity publication functionality provides the means for a group to preserve the memories of their group activity in a personalized, customized and professionally printed keepsake.

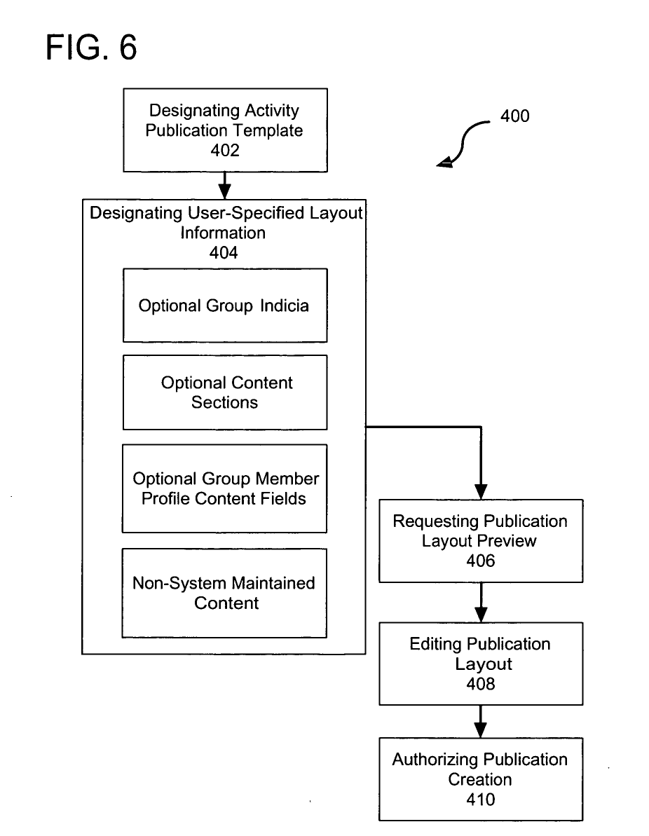

FIG. 6 depicts a method 400 of facilitating creation of a group activity publication by a group administrator. The various operations of the method 400 and the resulting system actions are facilitated via the administrator access level of the group website. In one embodiment, the group activity publication module 115 of the group management system 100 depicted in FIG. 1 at least partially enable system actions associated with the method 400.

An operation 402 is performed for designating a group activity publication template. It is contemplated herein that designation of the group activity template may be performed inferentially or expressly. For example, a type of group (e.g., a youth baseball team) designated by the group administrator during the team's registration may have a default group activity publication template associated therewith, or the group administrator may select one of a plurality of system-offered group activity publication templates.

An operation 404 is performed for specifying user-specified layout information for facilitating system-implemented formatting of the group activity publication template. The group activity publication template includes content fields corresponding to at least a portion of group information maintained by the information management module 105. Examples of such user-specified information include group color indicia (e.g., team colors), group image indicia (e.g., a team logo), optional content sections for the group activity publication template, optional group member profile content fields, and non-system maintained content (e.g., user-specified image files). After specifying the user-specified layout information, an operation 406 is performed for requesting preview of the group activity publication layout. In response to the group activity publication layout being created and displayed (i.e. previewed), an operation 408 is performed by the group administrator for editing the group activity publication layout (i.e., reviewing content and making any necessary changes), followed by an operation 410 for authorizing publication creation (e.g., outputting of a group activity publication layout instantiation).

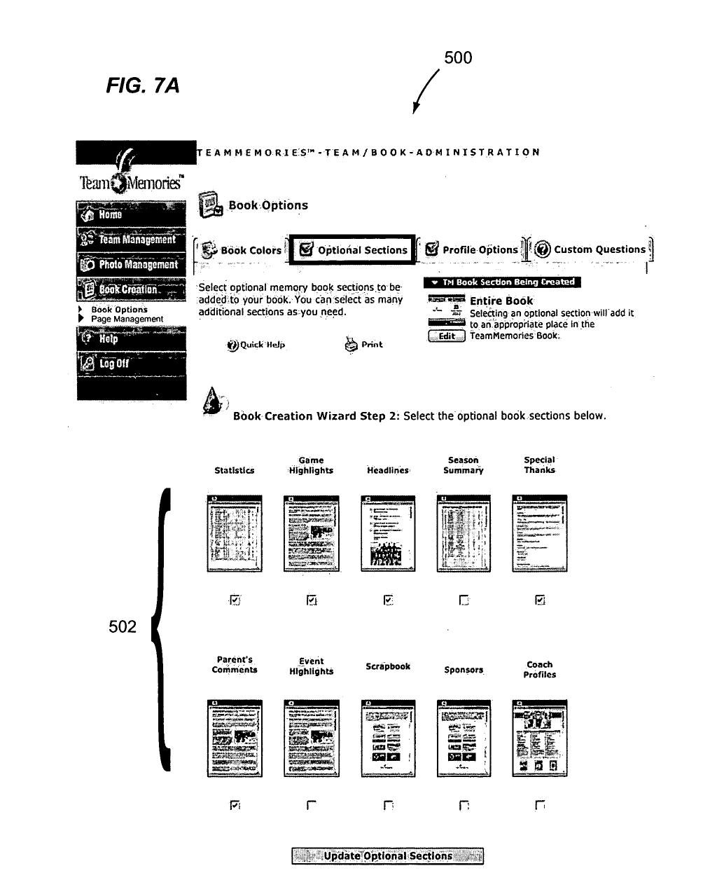

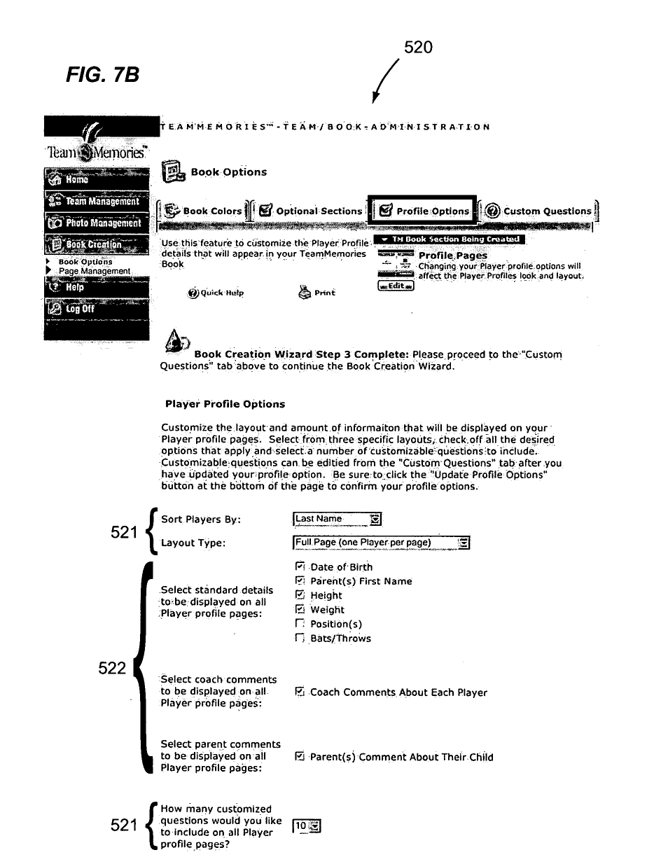

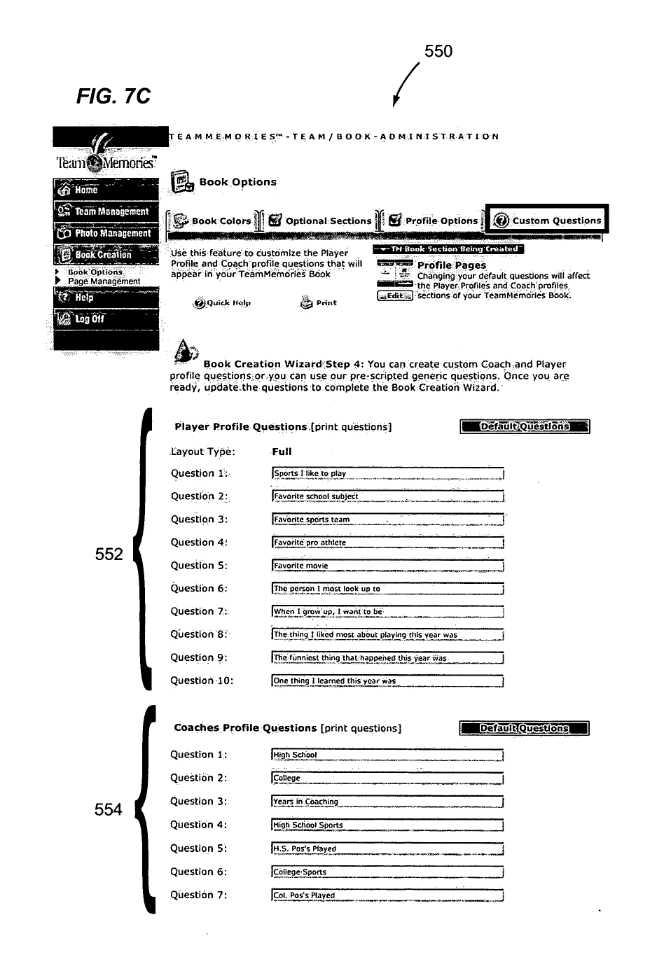

FIG. 7A depicts a webpage 500 that is configured for enabling selection of optional content sections of the group activity publication template, and that is accessible via the administrator home page 350 depicted in FIG. 3. The webpage 500 includes a plurality of optional content section selections 502 for the group activity publication template. Examples of the such optional content sections include a section for statistics, a section for highlights, a section for headlines, a section for activity final summary, a section for narrative comments, a section for image collections, a section for sponsor information and the like.

FIG. 7B depicts a webpage 520 that is configured for enabling designation of a profile layout options and selecting various participant profile content options for the group activity publication template. The webpage 520 is accessible via the administrator home page 350 depicted in FIG. 3. The webpage 520 includes a plurality of layout option selections 521 and a plurality of participant profile content selections 522. Examples of such layout option selections include a selection for specifying the manner in which participant profiles are sorted (i.e., arranged), a selection specifying a profile layout configuration (e.g., full-page, half-page or quarter-page) and a selection for specifying the number of customized questions to included in each participants profile. Examples of such participant profile selections include selections for specifying a date of birth, a height a weight and/or a role of a participant, a selection for enabling coach's comments about each participant to be included and a selection for enabling parent's comments about their child to be included. In at least one embodiment, at least a portion of the layout option selections 521 and participant profile content selections 522 carry over to respective layout and content aspects of the group website 300.

FIG. 7C depicts a webpage 550 that is configured for enabling designation of participant profile content for the group activity publication template, and that is accessible via the administrator home page 350 depicted in FIG. 3. The webpage 550 includes a plurality of participant profile questions 552 and a plurality of coaches (i.e., team staff) profile questions 554. In at least one embodiment, profile content corresponding to the participant profile questions 552 and the plurality of coaches profile questions 554 carries over to participant profile content displayable on the group website 300.

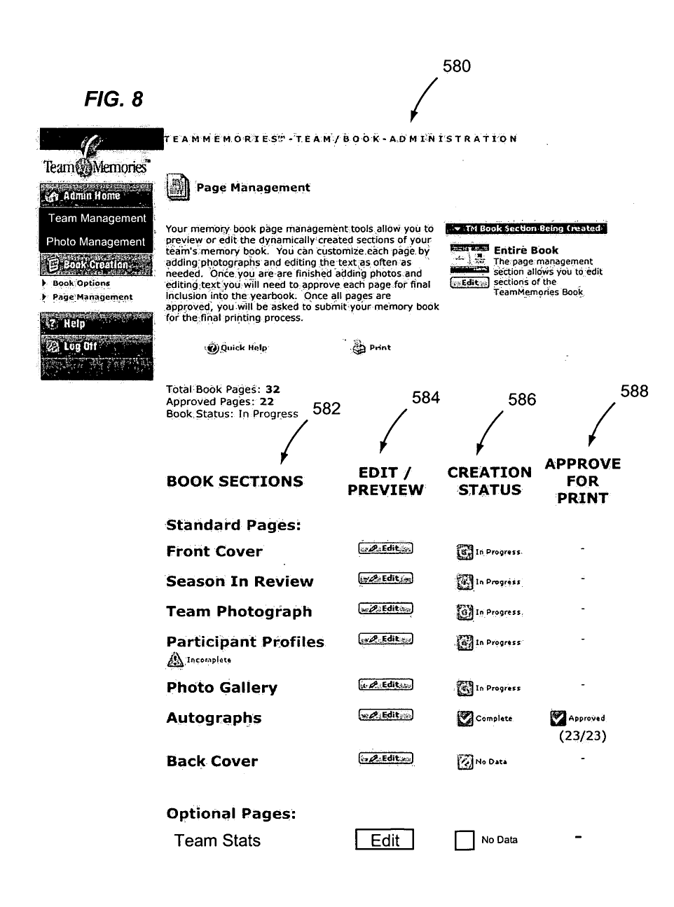

FIG. 8 depicts a webpage 580 that is configured for enabling various editing and approval functionality (i.e., formatting functionality) to be facilitated for a group activity publication layout, and that is accessible via the administrator home page 350 depicted in FIG. 3. The webpage 580 includes displayable content configured for facilitating formatting of the group activity publication layout. The displayable content includes a collection (i.e., listing) of active publication sections 582, a section edit preview selection 584 associated with each one of the active publication sections 582, a creation status field 586 associated with each one of the active publication sections 582, and a print approval field 588 associated with each one of the active publication sections 582.

Examples of the active publication sections 582 include a team roster section, a participant profile section, an activity results section, a headlines section, an activity summary section, a narrative comments section, an image gallery section and a sponsor section. Each section edit preview selection 584 enables content of a respective one of the active publication sections 582 to be edited. Each creation status field 586 designates a current creation status of a respective one of the active publication sections 582. Examples of current creation statuses include in-progress, a status designating that preparation of the section is completed and a status designating that preparation of the section is yet to begin. Each print approval field 588 designates a current print approval status of a respective one of the active publication sections 582. Examples of current print approval statuses include a status designating that the section is approved for printing and a status designating that the section is not yet approved for printing.

In one embodiment of the disclosures made herein, facilitating creation of a group activity publication layout instantiation (e.g., an output file) by the group management system includes populating a corresponding group activity publication template with appropriate portions of information maintained via the information module 105 of a group management system 100. It is contemplated herein that the corresponding group activity publication template may be defined inferentially or expressly. For example, a type of group (e.g., a youth baseball team) designated by the group administrator during the team's registration may have a default group activity publication template associated therewith, or the group administrator may select one of a plurality of system-offered group activity publication templates. In one embodiment, the group activity publication template is an informational template that defines relational information structures such as publication layout parameters for content and associations between group information (e.g.,) and content fields of the group activity publication. Prescribed portions of system-maintained group information and non-system maintained information comprise the content for the group activity publication template.

In one embodiment of the disclosures made herein, creating the group activity publication layout includes accessing group activity publication layout information in response to a user requesting creation of an activity publication, associating at least a portion of the textual content fields with respective portions of content of the website structure instantiation, and associating each one of the image content fields with a respective one of a plurality of image instantiations. The group activity publication layout information designates a plurality of textual content fields and a plurality of image content fields.

In one embodiment of the disclosures made herein, creating the group activity publication layout includes accessing group activity publication layout information corresponding to the group instantiation and associating each one of the publication content fields with a respective portion of the information representing the group of members and the group activity participated in by the members. The group activity publication layout information designates a plurality of publication content fields.

In summary of group activity publication functionality, an embodiment of such functionality includes receiving a request for creating a group activity publication layout, accessing group activity publication layout information in response to receiving the request, preparing a group activity publication layout including at least a portion of the publication content fields, and outputting a displayable representation of the group activity publication layout. The group activity publication layout information designates a plurality of publication content fields and content representation information corresponding to each one of the publication content fields. Preparing the group activity publication layout is performed at least partially dependent upon the representation information, and includes associating each one of the publication content fields with a respective portion of the group information. The group activity publication layout information includes at least one of system-defined information and user-designated information.

The content representation information includes at least one of relative content field positioning information, content field size information and instantiation association information (e.g., data associating group information with group activity publication content fields). The displayable representation includes representing portions of publication content corresponding to each one of the system-defined publication content fields at a respective position thereof and representing a portion of the publication content corresponding to the optional publication content field at a respective position thereof. The publication content fields include a plurality of system-defined publication content fields and an optional publication content field. A system-defined layout position is associated with each one of the system-defined publication fields. One of a system-defined layout position and a user-specified layout position is associated with the optional publication content field. Preparing the group activity publication layout includes integrating the optional publication content field at one of the system-defined layout position and the user-specified layout position.

An integral portion of disclosed methods and systems is the ability to upload images (e.g., photos) and incorporate them in a customized manner into website layouts and/or group activity publication layouts. Disclosed methods and systems enable such images to be managed in an efficient and simple manner. Preferably, such managing of images includes uploading images and storing images in a context-specific manner (e.g., context-specific folders).

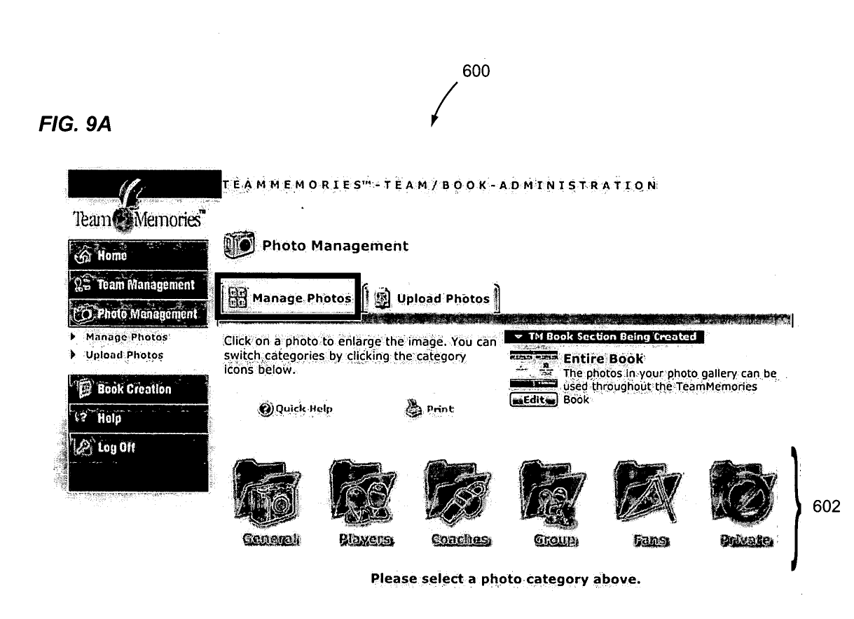

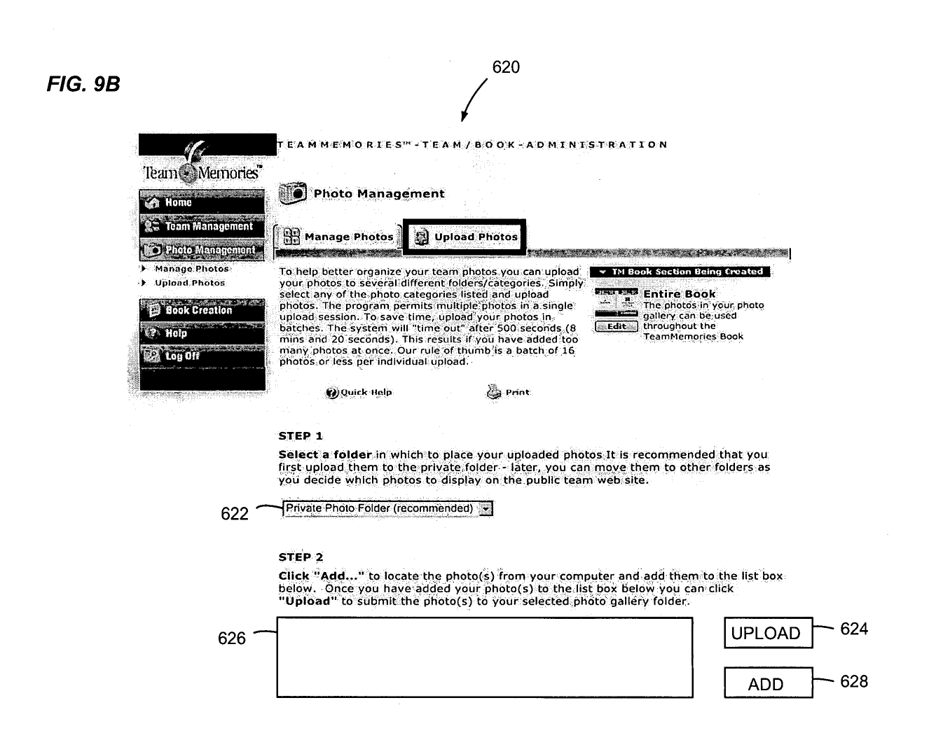

FIG. 9A depicts a webpage 600 that is configured for enabling management of images (i.e., image files) accessible for use in a groups website and/or group activity publication. The webpage 600 is accessible via the administrator home page 350 depicted in FIG. 3. The webpage 600 includes a plurality of context-specific folders 602 in which images may be placed and accessed. Through such content specific-folders 602, images may be organized and accessed in an efficient, convenient and simple manner. Examples of the such context-specific folders 602 include a folder for images of a general nature, a folder for images relating to players, a folder for images relating to coaches, a folder for images relating to the group, a folder relating to images relating to fans/family of the group, and the like.

FIG. 9B depicts a webpage 620 that is configured for enabling images to be uploaded to a respective one of the folders depicted in FIG. 9A. The webpage 620 is accessible via the administrator home page 350 depicted in FIG. 3. The webpage 620 includes a folder selection field 622 for designating a folder (i.e., one of the folders depicted in FIG. 9A) into which one or more images will be uploaded. An Add Button 624 is provided for enabling desired images on designated computer (e.g., the administrator's computer) to be located and selected. Selecting the Add Button 624 allows selected image files to be browsed and selected for uploading. Selected image files are identified within the file upload field 626. Selection of an Upload Button 628 initiates uploading of the selected image files into the designated folder (e.g., into a file storage unit of the disclosed system).

Referring now to computer readable medium in accordance with embodiments of the disclosures made herein, methods as disclosed herein are tangibly embodied by computer readable medium having instructions thereon for carrying out such methods. In one specific embodiment, instructions are provided for carrying out various operations of the method 200 depicted in FIG. 2, which is configured for facilitating manipulation of information compiled by members of a group. The instructions are accessible by a data processing device of a data processing system (e.g., a server) from a memory apparatus of the data processing system (e.g. RAM, ROM, virtual memory, hard drive memory, etc), from an apparatus readable by a drive unit of the data processing system (e.g., a diskette, a compact disk, a tape cartridge, etc) or both. Examples of computer readable medium include a compact disk or a hard drive, which has imaged thereon a computer program for carrying out financial consulting services functionality in accordance with embodiments of the disclosures made herein.

In one embodiment, group management systems in accordance with embodiments of the disclosures made herein are designed around a known and commercially-available architecture structure such as Microsoft.Net brand server technology. Preferred architecture structures include features and functionality that are supported by a database (i.e., a dynamic information structure instantiation) that allows for dynamic modifications to a group's information (i.e., directly in response to corresponding changes to such information). Such an architecture structure supports automatic changes to a group's website and the layout of their personalized memory book in response to corresponding changes to group information.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A computer-implemented method for facilitating group management functionality, comprising:
maintaining a group instantiation including information representing a group of members and a group activity participated in by said members;
creating a website structure instantiation including content fields corresponding to at least a portion of said information; and
creating a group activity publication layout including content fields corresponding to at least a portion of said information.

2. The method of claim 1 wherein:
maintaining the information instantiation is performed by an information management module of a group management system;
creating the website structure instantiation is performed by a group communication module of the group management system; and
creating the group activity publication layout is performed by a group activity publishing module of the group management system.

3. The method of claim 1 wherein:
creating the website structure instantiation includes associating each one of said website structure instantiation content fields with a respective portion of said information; and
creating the group activity publication layout includes associating at least a portion of said publication layout content fields with respective portions of said information.

4. The method of claim 1 wherein:
said information includes an administrator dataset and a plurality of participant datasets;
the administrator dataset includes administrator content for at least one of the group activity publication and the website structure instantiation and includes content parameters for at least one of a group activity publication and a website structure instantiation;
each one of said participant datasets includes participant content for at least one of the group activity publication and the website structure instantiation; and
creating the website structure instantiation includes populating a website template instantiation with respective portions of said participant content and said administrator content at least partially dependent upon said content parameters.

5. The method of claim 4, further comprising:
automatically updating content of the website structure instantiation in response to corresponding portions said datasets being altered thereby enabling said content of the website structure instantiation being dynamically maintained.

6. The method of claim 1 wherein creating the website structure instantiation includes:
providing the website structure instantiation with a first access level through which group activity publication creation functionality is exclusively accessible;
providing the website structure instantiation with a second access level including a plurality of respective content fields, wherein a first portion of said content fields of the second access level are system-defined and a second portion of said content fields of the second access level are specified through access to the first access level; and
providing the website structure instantiation with a third access level including publicly accessible content, wherein information comprising said publicly accessible content is inputted though at least one of the first access level and the second access level.

7. The method of claim 1 wherein:
the group activity publication layout includes a plurality of publication content fields; and
said creating the group activity publication layout includes associating each one of said publication content fields with a respective portion of said information.

8. The method of claim 1 wherein:
creating the group activity publication includes preparing a group activity publication layout, wherein the group activity publication layout includes system-defined content fields and optional content fields corresponding to user-selected publication content options.

9. The method of claim 1 wherein creating the group activity publication layout includes:
accessing group activity publication layout information in response to a user requesting creation of an activity publication, wherein said group activity publication layout information designates a plurality of textual content fields and a plurality of image content fields;
associating at least a portion of said textual content fields with respective portions of content of the website structure instantiation; and
associating each one of said image content fields with a respective one of a plurality of image instantiations.

10. The method of claim 1 wherein creating the group activity publication layout includes:
accessing group activity publication layout information corresponding to the group instantiation, wherein said group activity publication layout information designates a plurality of publication content fields; and
associating each one of said publication content fields with a respective portion of said information representing the group of members and the group activity participated in by said members.

11. A group management system, comprising:
at least one data processing device;
instructions processable by said at least one data processing device; and
an apparatus from which said instructions are accessible by said at least one data processing device;
wherein said instructions are configured for enabling said at least one data processing device to facilitate:
maintaining a group instantiation including information representing associated with a group of members and a group activity participated in by said members;
creating a website structure instantiation including content fields corresponding to at least a portion of said information; and
creating a group activity publication layout including content fields corresponding to at least a portion of said information.

12. The system of claim 11 wherein:
maintaining the information instantiation is performed by an information management module of a group management system;
creating the website structure instantiation is performed by a group communication module of the group management system; and
creating the group activity publication layout is performed by a group activity publishing module of the group management system.

13. The system of claim 11 wherein:
creating the website structure instantiation includes associating each one of said website structure instantiation content fields with a respective portion of said information; and
creating the group activity publication layout includes associating at least a portion of said publication layout content fields with respective portions of said information.

14. The system of claim 11 wherein:
said information includes an administrator dataset and a plurality of participant datasets;
the administrator dataset includes administrator content for at least one of the group activity publication and the website structure instantiation and includes content parameters for at least one of a group activity publication and a website structure instantiation;
each one of said participant datasets includes participant content for at least one of the group activity publication and the website structure instantiation; and
creating the website structure instantiation includes populating a website template instantiation with respective portions of said participant content and said administrator content at least partially dependent upon said content parameters.

15. The system of claim 14 wherein said at least one data processing device is further configured for automatically updating content of the website structure instantiation in response to corresponding portions said datasets being altered thereby enabling said content of the website structure instantiation being dynamically maintained.

16. The system of claim 11 wherein creating the website structure instantiation includes:
providing the website structure instantiation with a first access level through which group activity publication creation functionality is exclusively accessible;
providing the website structure instantiation with a second access level including a plurality of respective content fields, wherein a first portion of said content fields of the second access level are system-defined and a second portion of said content fields of the second access level are specified through access to the first access level; and
providing the website structure instantiation with a third access level including publicly accessible content, wherein information comprising said publicly accessible content is inputted though at least one of the first access level and the second access level.

17. The system of claim 11 wherein:
the group activity publication layout includes a plurality of publication content fields; and
creating the group activity publication layout includes associating each one of said publication content fields with a respective portion of said information.

18. The system of claim 11 wherein creating the group activity publication includes preparing a group activity publication layout, wherein the group activity publication layout includes system-defined content fields and optional content fields corresponding to user-selected publication content options.

19. The system of claim 11 wherein creating the group activity publication layout includes:
accessing group activity publication layout information in response to a user requesting creation of an activity publication, wherein said group activity publication layout information designated a plurality of textual content fields and a plurality of image content fields;
associating at least a portion of said textual content fields with respective portions of content of the website structure instantiation; and
associating each one of said image content fields with a respective one of a plurality of image instantiations.

20. The system of claim 11 wherein creating the group activity publication layout includes:
accessing group activity publication layout information corresponding to the group instantiation, wherein said group activity publication layout information designates a plurality of publication content fields; and
associating each one of said publication content fields with a respective portion of said information representing the group of members and the group activity participated in by said members.

21. A group management system, comprising:
an information management module configured for managing information associated with a group of members and a group activity participated in by said members;
a group activity publishing module configured for facilitating creation of a group activity publication layout; and
a communication module configured for automatically creating and dynamically maintaining a website structure instantiation.

22. The system of claim 21 wherein:
said facilitating creation of the group activity publication layout is performed dependent upon accessing at least a portion of said information maintained by the information management module; and
said creating and maintaining the website structure instantiation are performed dependent upon accessing at least a portion of said information maintained by the information management module

23. The system of claim 21 wherein each one of said modules are integrated with each other one of said modules for enabling sharing of information and functionality therebetween.

24. The system of claim wherein the communication module is further configured for for transmitting, for reception by a designated portion of said members, portions of said information maintained by the information management module.

25. The system of claim 21 wherein:
creating the website structure instantiation includes associating each one of the website structure instantiation content fields with a respective portion of said information; and
creating the group activity publication layout includes associating at least a portion of said publication layout content fields with respective portions of said information.

26. The system of claim 21 wherein:
creating the website structure instantiation includes populating a website template instantiation with portions of group content; and
said information includes said group content.
